(19) United States
(12) Patent Application Publication
(10) Pub. No.: US 2026/0011969 A1
(43) Pub. Date: Jan. 8, 2026

(54) METHOD AND APPARATUS FOR ADDITIVELY FABRICATING ELECTRICAL COMPONENTS

(71) Applicant: SAMTEC, INC., New Albany, IN (US)

(72) Inventors: Thomas Albert HALL, III, New Albany, IN (US); Troy Benton HOLLAND, New Albany, IN (US)

(21) Appl. No.: 18/992,380

(22) PCT Filed: Jul. 7, 2023
(86) PCT No.: PCT/US2023/069742

§ 371 Date: Jan. 8, 2025

Related U.S. Application Data
(60) Provisional application No. 63/359,487, filed on Jul. 8, 2022.

(51) Int. Cl. H01R 43/20; B21D 22/02

(52) U.S. Cl. CPC H01R 43/20; B21D 22/02

(57) ABSTRACT

Methods and apparatus are provided for additively fabricating an electrical component such as an electrical connector. An additive manufacturing station includes at least two beams that intersect in a bath of resin, such that the combined energy of the beams at the intersection is sufficient to crosslink the resin.

### CROSS-REFERENCE TO RELATED APPLICATIONS

This claims priority to U.S. Patent Application Ser. No. 63/359,487 filed Jul. 8, 2022, the disclosure of which is hereby incorporated by reference as if set forth in its entirety herein.

### BACKGROUND

Electrical connectors typically include a plurality of electrical contacts supported by an electrically insulative housing. At least one of the electrical contacts can be configured to transmit electrical signals between electrical devices in one example. At least one of the electrical contacts can be configured to transmit electrical power in other examples.

In some constructions, the electrical contacts can be directly supported by an electrically insulated connector housing. For instance, the electrical contacts can be insert molded in the connector housing. Alternatively, the electrical contacts can be stitched into the connector housing. In other constructions, the electrical contacts can be directly supported by respective electrically insulated leadframe housings to define a corresponding plurality of leadframe assemblies that, in turn, are installed into the connector housing. For instance, the electrical contacts can be insert molded in respective ones of the leadframe housings. In other examples, the electrical contacts can be stitched into the leadframe housings.

Whether the electrical contacts are directly supported by the connector housing or by one of the leadframe housings, it is desirable to provide other methods and apparatus for support electrical contacts in an electrically insulative housing.

### SUMMARY

In one aspect, a method is provided for additively fabricating an electrical component. The method can include the step of directing first and second light beams from first and second light sources, respectively, toward a resin. The first and second directed light beams can have respective energy levels that are insufficient to crosslink the resin. The method can further include the step of intersecting the first and second light beams in the resin so as to define a location of beam intersection. The location of beam intersection can define an elongate line and can have an energy level sufficient to crosslink the resin. The intersecting step can crosslink the resin and bond the resin to a plurality of electrical contacts when the location of beam intersection is in the resin.

### BRIEF DESCRIPTION OF THE DRAWINGS

FIG. 1A is a rear elevation view of an electrical connector constructed in accordance with one example;

FIG. 1B is a front elevation view of the electrical connector of FIG. 1A;

FIG. 1C is a perspective view of the electrical connector of FIG. 1A;

FIG. 1D is another perspective view of the electrical connector of FIG. 1A;

FIG. 1E is a perspective view of a leadframe assembly among a plurality of leadframe assemblies of the electrical connector of FIG. 1A;

FIG. 2A is a schematic perspective view of an additive fabrication system in one example;

FIG. 2B is a schematic side elevation view of the additive fabrication system of FIG. 2A;

FIG. 3A is a schematic perspective view of first and second light sources directing first and second light beams to intersect at a location of beam intersection in a resin bath so as to crosslink the resin;

FIG. 3B is a schematic side elevation view of the first and second light sources illustrated in FIG. 3A, showing the location of beam intersection disposed in a crosslink plane;

FIG. 3C is a schematic side elevation view of the first and second light sources illustrated in FIG. 3B, but showing the location of beam intersection moved within a crosslink plane;

FIG. 3D is a schematic side elevation view of the first and second light sources illustrated in FIG. 3C, but showing the location of beam intersection moved to another crosslink plane;

FIG. 3E is a schematic view of a light engine for each of the first and second light sources illustrated in FIG. 3A;

FIG. 3F is a schematic perspective view of the first and light sources of FIG. 3A, but showing each of the light sources segmented in another example;

FIG. 3G is a schematic perspective view of the first and light sources of FIG. 3A, but showing each of the light sources emitting a plurality of light beams in another example; and

FIG. 4A is a schematic perspective view of an initial fabrication station of the fabrication system illustrated in FIG. 2A;

FIG. 4B is a schematic side elevation view of the initial fabrication station of FIG. 4A;

FIG. 5A is a schematic perspective elevation view of an initial fabrication station in another example;

FIG. 5B is a schematic sectional elevation view of the initial fabrication station of FIG. 5A, showing polymer being crosslinked onto a platform of a shuttle;

FIG. 5C is a schematic sectional elevation view similar to FIG. 5B, but showing the shuttle moved to a position whereby the crosslinked polymer on the platform is aligned with a plurality of electrical contacts;

FIG. 5D is a schematic sectional elevation view similar to FIG. 5C, but showing polymer being crosslinked to bond to the electrical contacts and the polymer that was crosslinked on the platform;

FIG. 5E is a schematic sectional elevation view similar to FIG. 5D, but showing the shuttle removed from the crosslinked polymer;

FIG. 6A is a schematic side elevation view of a subsequent fabrication station and an ablation station of the additive fabrication system of FIG. 2A; and

FIG. 6B is a schematic side elevation view of an ablation station of the additive fabrication system of FIG. 2A.

### DETAILED DESCRIPTION

It should be appreciated that reference herein to a singular apparatus or method step applies with equal force and effect to each of the plural and “at least one.” Similarly, reference herein to plural apparatus or method steps applies with equal force and effect to each of the singular and “at least one.” Reference herein to “at least one” apparatus or method step includes both the singular and the plural.

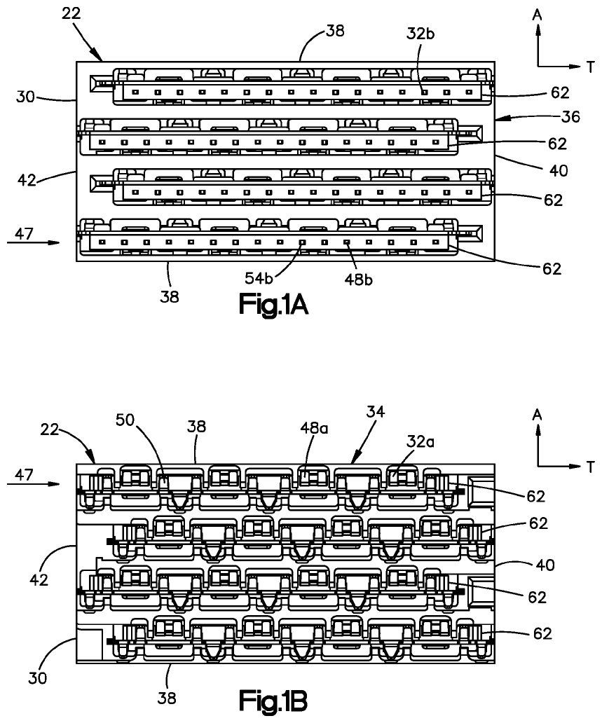

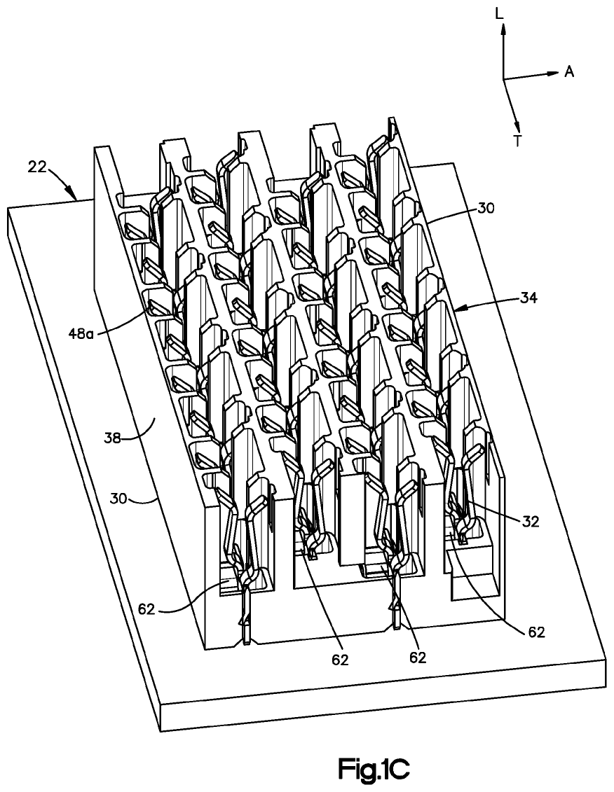

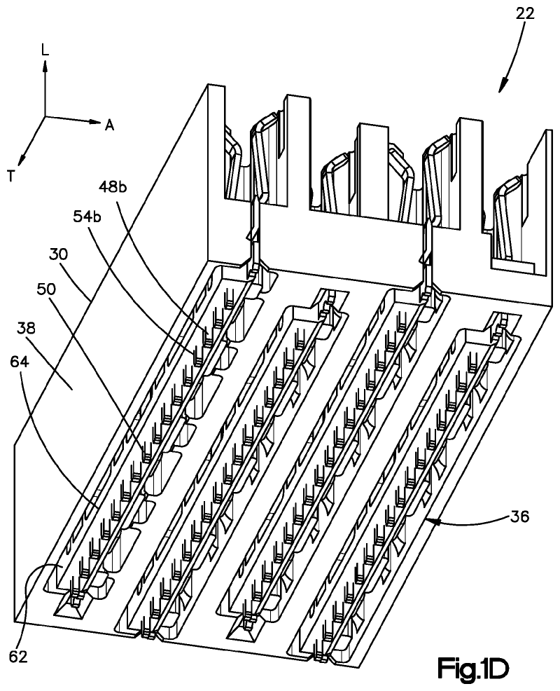

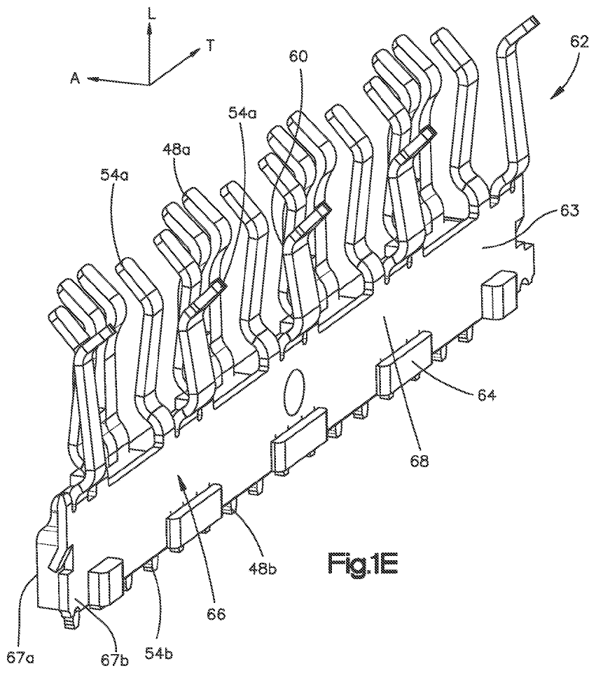

Disclosed herein are methods and apparatus for fabricating an electrical connector or leadframe assemblies for an electrical connector. In particular, an electrically insulative housing can be additively manufactured onto a plurality of electrical contacts of an electrical connector. Referring initially to FIGS. 1A-1E, one example of an electrical connector 22 can include a dielectric or electrically insulative connector housing 30 and a plurality of electrical contacts 32 that are supported indirectly or directly by the connector housing 30. As will be appreciated below, the electrical contacts 32 can include signal contacts and grounds. In other examples, the electrical contacts 32 can be configured as electrical power contacts.

The connector housing 30 defines a front end that, in turn, defines a mating interface 34. The connector housing 30 further defines a rear end that, in turn, defines a mounting interface 36 opposite the mating interface 34 along a longitudinal direction L. The longitudinal direction L can define a height of the connector housing 30. Further, the mating interface 34 can be aligned with the mounting interface 36 along the longitudinal direction L. The electrical contacts 32 can define respective mating ends 32a at the mating interface 34, and mounting ends 32b at the mounting interface 36. Thus, the electrical contacts 32 can be configured as vertical contacts whose mating ends 32a and mounting ends 32b are opposite each other with respect to the longitudinal direction L. As will be appreciated from the description below, the electrical connector 22, and thus the electrical connector system 20, can include a plurality of electrical cables that are mounted to the electrical contacts 32 at the mounting interface 36. Because the mating ends 32a and the mounting ends 32b are opposite each other along the longitudinal direction L, and oriented along the longitudinal direction L, the electrical contacts 32 can be referred to as vertical contacts. The electrical connector 22 can be referred to as a vertical connector whose mating interface 34 is opposite the mounting interface 36 along the longitudinal direction L, and inline with the mounting interface 36 along the longitudinal direction L. Alternatively, the electrical connector 22 can be configured as a right-angle connector, whereby the mating ends 32a are oriented along the longitudinal direction L and the mounting ends 32b are oriented along a transverse direction T that is oriented perpendicular to the longitudinal direction L. Similarly, the mating interface 34 can be oriented along the longitudinal direction 34, and the mounting interface 36 can be oriented along the transverse direction T.

The longitudinal direction L defines a forward mating direction along which the electrical connector 22 mates with a complementary electrical component, which can be configured as a complementary electrical connector. When the electrical connector 22 is configured as a vertical connector, the longitudinal direction defines a rearward mounting direction that is opposite the forward mating direction along which the electrical connector 22 mounts to a complementary electrical device, such as a substrate 26, which can be configured as a printed circuit board (PCB) in one example. The PCB can define a backplane other suitable underlying substrate. In other examples, the mounting ends 32b can be mounted to electrical cables. When the electrical connector 22 is configured as a right-angle connector, the transverse direction T defines the mounting direction, which is thus perpendicular to the mating direction.

The connector housing 30 further defines and second external sides 38 that are opposite each other along a lateral direction A that is oriented substantially perpendicular to the longitudinal direction L and the transverse direction T. The lateral direction A can define a width of the connector housing 30. The connector housing 30 further defines a first external end 40 and a second external end 42 opposite the first external end 40 along the transverse direction T. The transverse direction T can define a length of the connector housing 30 from the underlying substrate.

The electrical contacts 32 can be arranged in respective linear arrays 47 that are oriented along a row direction which can extend along the transverse direction T. Thus, the first and second ends 40 and 42 can be said to be spaced from each other along the row direction. The linear arrays 47 can be oriented parallel to each other. The electrical connector 22 can include any number of linear arrays as desired. For instance, the electrical connector 22 can include two or more linear arrays 47. For instance, the electrical connector 22 can include three or more linear arrays 47. For instance, the electrical connector 22 can include four or more linear arrays 47. For instance, the electrical connector 22 can include five or more linear arrays 47. For instance, the electrical connector 22 can include six or more linear arrays 47. For instance, the electrical connector 22 can include seven or more linear arrays 47. For instance, the electrical connector 22 can include eight or more linear arrays 47. In this regard, it should be appreciated that the electrical connector 22 can include any number of linear arrays as desired. As will be further appreciated from the description below, the electrical connector 22 can include one or more ground shields 63 disposed between respective adjacent ones of the linear arrays 47.

The linear arrays 47 can be oriented substantially along the transverse direction T. Thus, reference to the linear array 47 and the transverse direction T herein can be used interchangeably unless otherwise indicated. Similarly, the linear arrays 47 can be oriented substantially along a direction that intersects the substrate 26 to which the electrical connector 22 is mounted. The term “substantially” recognizes that the electrical contacts 32 of each of the linear arrays can define regions that are offset from each other. For instance, one or more of the mating ends 32a can be offset from each other along the lateral direction A as desired. Further, the linear arrays 47 can be oriented in a direction that is substantially perpendicular to the plane of the substrate 26 to which the electrical connector 22 is attached.

The linear arrays 47 can be spaced from each other along a direction that is substantially parallel to the plane defined by the substrate 26 to which the electrical connector 22 is mounted. Thus, the linear arrays 47 can be spaced from each other along the lateral direction A. The lateral direction A can also be referred to as a column direction. Accordingly, the first and second sides 38 can be said to be opposite each other along the column direction. The mating ends 32a of each linear array 47 are spaced from the mating ends 32a of adjacent ones of the linear arrays 47 along the lateral direction A. Further, the mounting ends 32b of each linear array 47 are spaced from the mounting ends 32b of adjacent ones of the linear arrays 47 along the lateral direction A.

The electrical contacts 32 can include a plurality of signal contacts 48 and a plurality of electrical grounds 50 disposed between respective ones of the signal contacts 48. For instance, the adjacent ones of the signal contacts 48 that are adjacent each other along the linear array 47 can define a differential signal pair. While the signal contacts 48 and the grounds 50 can be said to extend along a linear array, it is recognized that at least a portion up to an entirety of the signal contacts and the grounds 50 can be offset with respect to each other along the lateral direction A. As described in more detail below, the signal contacts 48 and the grounds 50 can be said to be arranged along a respective linear array.

In one example, the signal contacts 48 of each differential pair can be edge coupled. That is, the edges of the contacts 48 that define differential pairs face each other. Alternatively, the electrical contacts 48 can be broadside coupled whereby the broadsides of the electrical contacts 48 of the differential pairs can face each other. The edges are shorter than the broadsides in a plane defined by the lateral direction A and the transverse direction T. The edges can face each other within each linear array. The broadsides of the electrical contacts 48 of adjacent linear arrays can face each other. Each adjacent differential signal pair along a respective one of the linear arrays 47 can be separated by at least one ground in a repeating pattern. Each of the signal contacts 48 can define a respective mating end 48a, a respective mounting end 48b, and an intermediate region that extends between the mating end 48a and the mounting end 48b. For instance, the intermediate region can extend from the mating end 48a to the mounting end 48b.

The mounting ends 48b can be placed in electrical communication with respective signal conductors of the complementary electrical device. Further, each of the grounds 50 can include at least one ground mating end 54a and at least one ground mounting end 54b. The ground mounting ends 54b can be placed in electrical communication with respective grounds of the complementary electrical device. The mating ends 32a of the electrical contacts 32 can include the mating ends 48a of the signal contacts 48 and the ground mating ends 54a. The mounting ends 32b of the electrical contacts 32 can include the mounting ends 48b of the signal contacts 48 and the ground mounting ends 54b.

The mating ends 48a of adjacent differential signal pairs along the linear array can be separated by at least one ground mating end 54a along the transverse direction T. In one example, the mating ends 48a of adjacent differential signal pairs can be separated by a plurality of ground mating ends 54a. The mounting ends 48b of adjacent differential signal pairs can be separated by at least one ground mounting end 54b along the transverse direction T. In one example, the mounting ends 48b of adjacent differential signal pairs can be separated by a plurality of ground mounting ends 54b. For instance, the mounting ends 48b of the signal contacts 48 can be separated by a pair of ground mounting ends 54b. The mounting ends 48b and the ground mounting ends 54b can be configured in any manner as desired, including but not limited to solder balls, press-fit tails, j-shaped leads. Alternatively, and as described above, the mounting ends 48b and the ground mounting ends 54b can be configured as cable mounts that attach to respective electrical conductors and electrical grounds of an electrical cable.

It is recognized that the grounds 50 can be defined by respective discrete ground contacts. Alternatively, the grounds 50 can be defined by a respective one of a plurality of ground plates 66. With continuing reference to FIGS. 1A-1E, in one example the electrical connector 22 can include a plurality of leadframe assemblies 62 that are supported by the connector housing 30. Each of the leadframe assemblies 62 can include a dielectric or electrically insulative leadframe housing 64, and a respective linear array 47 of the plurality of electrical contacts 32 supported by the leadframe housing 64. In one example, the electrical contacts 32 of each leadframe assembly 62 can extend through the respective leadframe housing 64. In particular, the leadframe housing 64 can have first and second exterior sides 67a and 67b that are opposite each other along the lateral direction A, and the electrical contacts 32 can extend through the leadframe housing 64 between the first and second sides exterior sides 67a and 67b. Thus, it can be said that each leadframe assembly 62 is oriented along one of the linear arrays 47 of the electrical connector. The lateral direction A can define a width of the leadframe housing 64. The transverse direction T can define a length of the leadframe housing 64. The longitudinal direction L can define a height of the leadframe housing 64.

As described above, the grounds of the respective linear array 47 can be defined by a ground plate 66 as described above. The ground plate 66 can include a plate body 68 that is supported by the leadframe housing 64, such that the ground mating ends 54a and the ground mounting ends 54b extend out from the plate body 68. Thus, the plate body 68, the ground mating ends 54a, and the ground mounting ends 54b can all be monolithic with each other. Respective ones of the ground plate bodies 68 can be disposed between respective adjacent linear arrays of the intermediate regions of the electrical signal contacts 48.

The ground plate 66 can be configured to electrically shield the signal contacts 48 of the respective linear array 47 from the signal contacts 48 of an adjacent one of the linear arrays 47 along the lateral direction A. Thus, the ground plates 66 can also be referred to as electrical shields. Further, it can be said that an electrical shield is disposed between, along the lateral direction A, adjacent ones of respective linear arrays of the electrical signal contacts 48. In one example, the ground plates 66 can be made of any suitable metal. In another example, the ground plates 66 can include an electrically conductive lossy material. In still another example, the ground plates 66 can include an electrically nonconductive lossy material.

The leadframe housing 64 of at least one or more up to all of the leadframe assemblies 62 can advantageously be additively manufactured onto the electrical signal contacts 48. Alternatively or additionally, the leadframe housing 64 can be additively manufactured onto the grounds 50. For instance, the leadframe housing 64 can be additively manufactured onto the ground plate 66. Alternatively, as described above, the grounds 50 can be configured as discrete grounds, and the leadframe housing 64 can be additively manufactured over the discrete grounds.

Alternatively still, the ground plate 66 can be discretely attached to the leadframe housing 64. For instance, each of the leadframe assemblies 62 can define at least one aperture 71 that extends through each of the leadframe housing 64 and the ground plate 66 along the lateral direction. The at least one aperture 71 can include a plurality of apertures 71. A perimeter of the at least one aperture 71 can be defined by a portion 65a of the leadframe housing 64. The portion 65a of the leadframe housing 64 can be aligned with the ground plate 66 along the lateral direction A. The leadframe housing 64 can further include a second portion 65b that cooperates with the portion 65a so as to capture the ground plate 66 therebetween along the lateral direction A. The quantity of electrically insulative material of the leadframe housing 64 can further control the impedance of the electrical connector 22. Further, a region of each at least one aperture 71 can be aligned with the signal mating ends 48a of the electrical signal contacts along the longitudinal direction L.

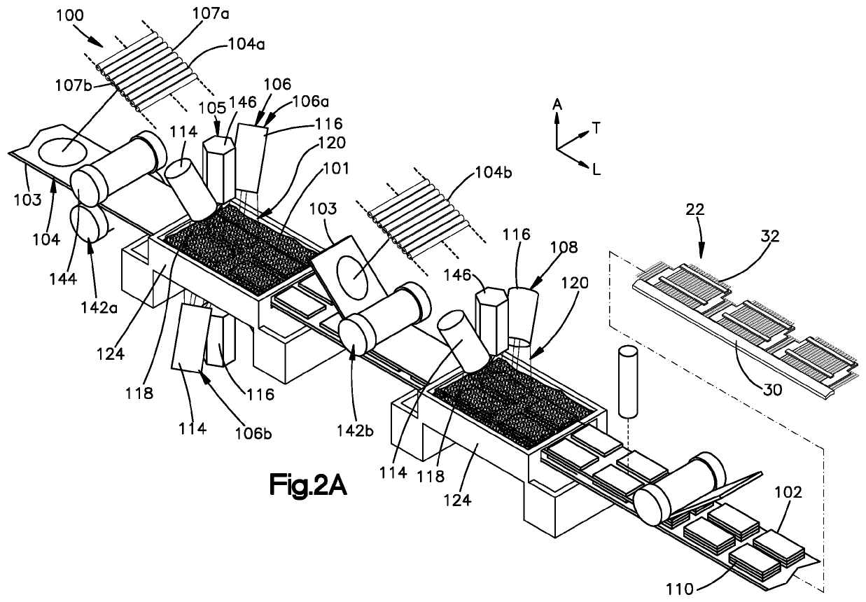

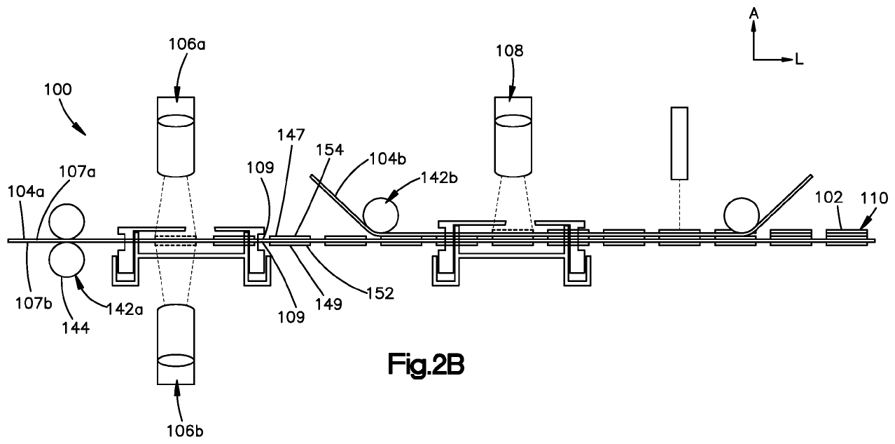

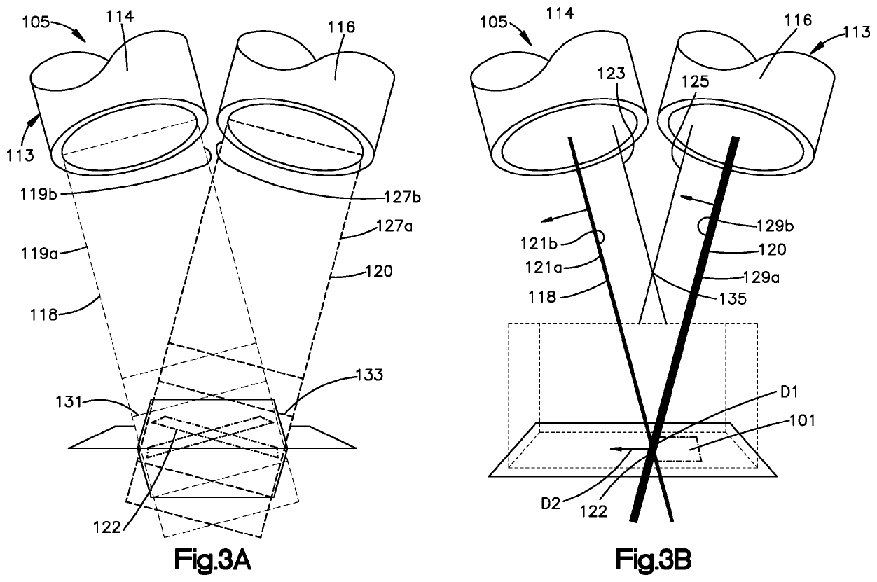

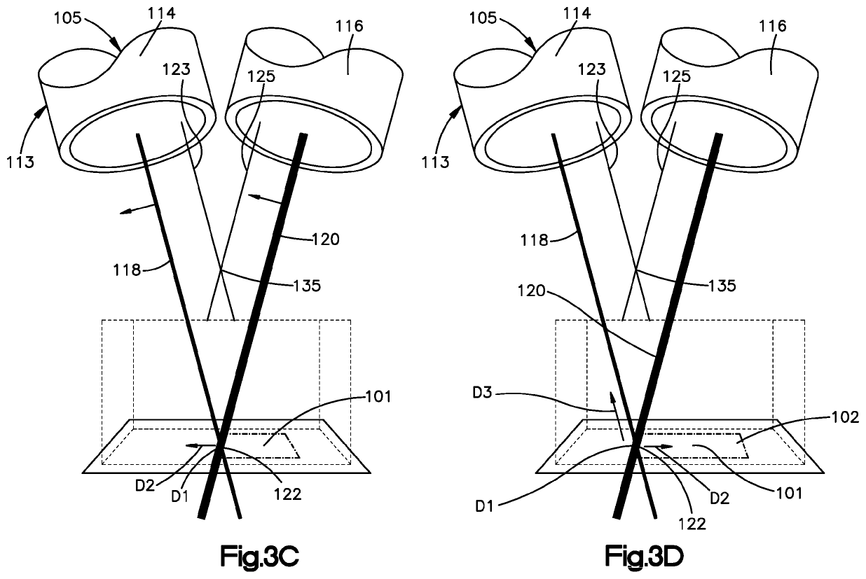

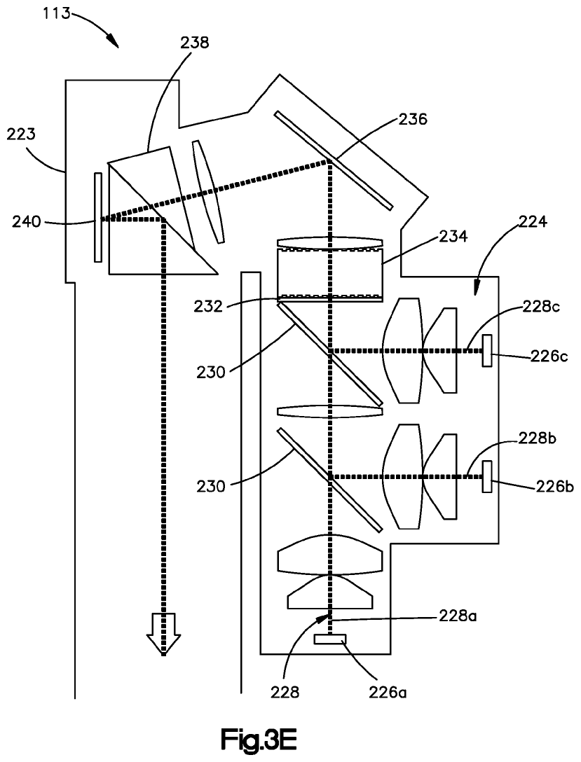

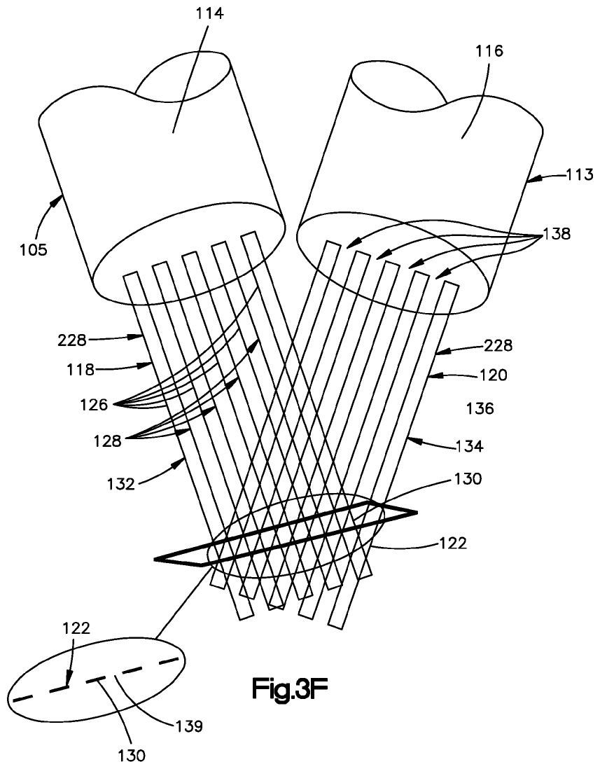

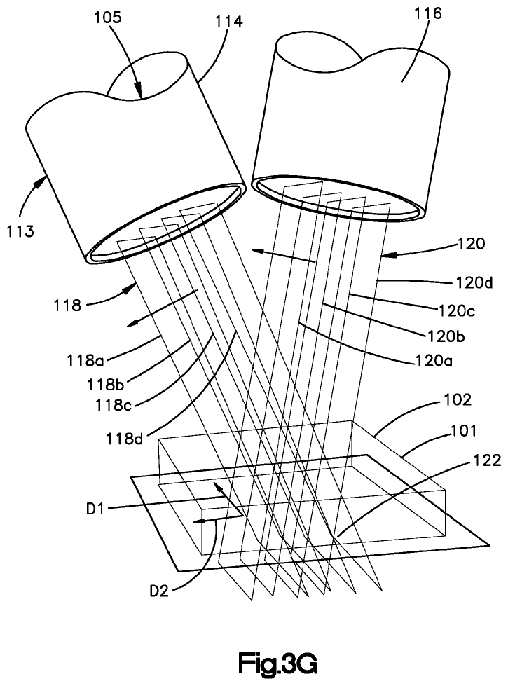

As will now be described with reference to FIGS. 2A-3G generally, a plurality of electrical contacts, which can be defined by either or both of the electrical contacts 22 and the electrical grounds 50, can be supported by an electrically insulative housing that is additively manufactured onto the electrical contacts. The additively manufactured housing can define a leadframe housing such as the leadframe housing 64 described above, or any suitable alternative leadframe housing. Alternatively, the additively manufactured housing can define a connector housing such as the connector housing 30 or any suitable alternative connector housing. Thus, the electrical contacts can be directly supported by the additively manufactured leadframe housing, which in turn can be supported by the connector housing. The connector housing can be additively manufactured, injection molded, or otherwise fabricated as desired. Alternatively, the electrical contacts can be directly supported by the additively manufactured connector housing.

Referring now to FIGS. 2A-2B in particular, an additive fabrication system 100 is configured to crosslink a viscous polymeric resin 101 so as to solidify the resin 101 such that a plurality of electrical contacts 104 are supported by the resulting electrically solid electrically insulative polymeric housing 102 that is defined by the cross-linked resin 101 so as to define a wafer 110. The electrical contacts 104 can include electrical signal contacts. The electrical contacts can further include electrical ground contacts. Alternatively, a ground plate can be secured to the wafer 110 so as to define ground mating ends and ground mounting ends in the manner described above. As will be appreciated from the description below, the additive fabrication system 100 can be configured to mass produce additively fabricated wafers 110.

The wafer 110 can include the housing 102 and a plurality of electrical contacts 104 supported by the housing 102. At regions whereby the resin 101 is in contact with the plurality of electrical contacts 104, crosslinking the resin 101 can cause the resin 101 to bond to the electrical contacts 104. The electrical contacts 104 can be configured as the electrical contacts 32, including either or both of the signal contacts 48 and the grounds 50 as described above. The wafer 110 can define a leadframe assembly such as the leadframe assembly 62 of the type described above with reference to FIGS. 1A-1E, such that the housing 102 defines a leadframe housing such as the electrically insulative leadframe housing 64 of the type described above. Alternatively, the wafer 110 can define an electrical connector whereby the housing 102 defines an insulative connector housing, such as the connector housing 30 described above.

The additive fabrication system 100 can include at least one additive fabrication station 105, such as an initial fabrication station 106, that is configured to produce the wafer 110 that includes a respective first region of crosslinked resin 147 and a respective first row defined by a first plurality of electrical contacts 104a supported by the first region of crosslinked resin 147. The first plurality of electrical contacts 104a can be arranged along a respective linear array as desired. The at least one fabrication station 105 can further include one or more subsequent fabrication stations 108 that can be configured to add a second row defined by a second plurality of electrical contacts 104b to the wafer 110 produced at the preceding fabrication station 105. One or more subsequent fabrication stations 108 can add corresponding one or more additional rows of electrical contacts and crosslinked resin 101 to the wafer 110 produced at the preceding fabrication station. The additive fabrication system 100 can include any number of subsequent fabrication stations 108 as desired depending on the number of rows of electrical contacts to be included in the resulting wafer 110. The electrical contacts of each row can be oriented perpendicular to a direction of travel through each fabrication station.

It should be appreciated that the subsequent fabrication station 108 is a subsequent station with respect to the initial fabrication station 106, and that the initial fabrication station 106 is a preceding fabrication station with respect to the subsequent fabrication station 108. The subsequent fabrication station 108 that immediately follows the initial fabrication station 106 can be a preceding fabrication station with respect to a subsequent fabrication station 108 that follows the subsequent fabrication station 108 that follows the initial fabrication station, and so forth. While the additive fabrication system 100 includes the initial and subsequent fabrication stations 106 and 108 in one example, in another example the additive fabrication system 100 can include only the initial fabrication station 106, and thus is configured to produce a plurality of wafers 110 having a single row of electrical contacts 104. In other examples, the additive fabrication system 100 can include the initial and one or more subsequent fabrication stations 106 and 108 so as to produce a wafer having multiple rows of electrical contacts 104. It should be appreciated that the additive fabrication station 100 can include any number of subsequent fabrication stations 108 as desired that sequentially add resin and respective rows of electrical contacts to the wafer 110 produced at a respective preceding fabrication station. Each fabrication station can be configured as described herein.

Referring now also to FIGS. 3A-3G, each fabrication station 105 can include a respective at least one light source 113 such as a respective pair of light sources, including a first light source 114 and a second light source 116. The first light source 114 produces at least one first light beam 118 and directs the first light beam 118 toward the resin 101. The second light source 116 produces at least one second light beam 120 and directs the second light beam 120 toward the resin 101. The resin 101 can be provided as a bath of viscous resin 101 that is disposed in a tank 124 that has an open or optically transparent end. The first and second beams 118 and 120 can extend through the open end or the optically transparent end.

The light sources 114 and 116 can be configured as lasers, such that the first and second light beams 118 and 120 are ultraviolet (UV) laser beams. Thus, the resin 101 can be any suitable UV transparent polymer resin. In one example, the first light beam 118 has a first energy level that is below the energy level required to cross-link the resin 101. The second light beam 120 also can have a second energy level that is below the energy level required to cross-link the resin 101. However, when the light beams 118 and 120 intersect each other at a location of beam intersection 122, the first and second energy levels combine to produce a combined energy level at the location of beam intersection 122. In one example, the energy levels can be in a range from approximately 1 mJ/cm² to approximately 2000 mJ/cm² depending on the dwell time in which the resin is exposed to the li for curing. The combined energy level is greater than the energy level required to cross-link the resin 101. Thus, the first and second light beams 118 and 120 can cause the resin 101 to crosslink at the location of beam intersection 122. In one example, each of the light sources 114 and 116 can be substantially identical light sources, subject to manufacturing tolerances.

As shown in FIGS. 3A-3B, it can be desirable to position the location of beam intersection 122 in the respective full telecentric zones 131 and 133 of the first and second light beams 118 and 120, respectively. As shown in FIG. 3C, it is recognized that the first and second light sources 114 and 116 can produce Moiré effects 123 and 125 that intersect at a Moiré effect intersection 135, and the intersection of the Moiré effects 123 and 125 can produce energy levels sufficient to cross-link the resin 101. Thus, in some examples the first and second light beams 118 and 120 can be positioned to maintain the intersecting Moiré effects 123 and 125, also referred to as Moiré interference, at a location spaced from the resin 101, and thus out of the resin 101. Accordingly, in some examples the only cross-linking of the resin 101 can occur in response to intersection of the first and second light beams 118 and 120 in the resin 101. During use, the light beams 118 and 120 can be directed into the resin 101 and subsequently intersected to define the location of beam intersection at a desired location in the resin 101. In other examples, the location of beam intersection can occur simultaneously with the step of directing the light beams 118 and 120 into the resin 101

The first light beam 118 extends from the first light source 114 along a first length to the resin 101. The first light beam 118 has a first width that is perpendicular to the first length, and a first thickness that is perpendicular to both the first length and the first width. The first length and the first width can extend along a first common light beam plane. The first width is greater than the first thickness. The first length can be greater than the first width. In particular, the first light beam 118 can define a first edge 119a and a second edge 119b opposite the first edge 119a along a first width direction. The width can be defined by a shortest distance from the first edge 119a to the second edge 119b along the first width direction. The first light beam 118 can define a first surface 121a and a second surface 121b opposite the first surface 121a along a first thickness direction. The thickness can be defined by a shortest distance from the first surface 121a to the second surface 121b along the first thickness direction. The first length extends along each of the first and second edges 119a-119b and the first and second surfaces 121a-121b.

Similarly, the second light beam 120 extends from the second light source 116 along a second length to the resin 101. The second light beam 120 has a first width that is perpendicular to the second length, and a second thickness that is perpendicular to both the second length and the second width. The second length and the second width can extend along a second common light beam plane. The second width is greater than the second thickness. The second length can be greater than the second width. In particular, the second light beam 120 can define a first edge 127a and a second edge 127b opposite the first edge 127a along a second width direction. The second width can be defined by a shortest distance from the first edge 127a to the second edge 127b along the second width direction. The second light beam 120 can define a first surface 129a and a second surface 129b opposite the first surface 129a along a second thickness direction. The second thickness can be defined by a shortest distance from the first surface 129a to the second surface 129b along the second thickness direction. The second length extends along each of the first and second edges 127a-127b and the first and second surfaces 129a-129b.

In one example, the first and second lengths can be substantially equal to each other, the first and second widths can be substantially equal to each other, and the first and second thicknesses can be substantially equal to each other. However, in one example, in a single common plane, the light beams 118 and 120 can be oriented such that in the plane the second thickness is greater than the first thickness. In other examples, the first and second thicknesses can be substantially equal to each other in the single common plane. The first and second light beams 118 and 120 can be rectangular in cross-section. It should be appreciated, of course, that the first and second light beams 118 and 120 can be alternatively shaped as desired.

The first and second lengths can be defined by respective directions that are angularly offset from each other, such that the respective lengths of first and second beams converge toward each other from the respective first and second light sources until they intersect at the location of beam intersection 122 in the resin 101. The location of beam intersection 122 can define an elongate line. The elongate line can be straight in one example, and can extend continuously along an entirety of either or both of the first and second widths. Alternatively, depending on the shapes of the first and second light beams 118 and 120, the elongate line can be curvilinear. In some examples, when first and second width directions that define the first and second widths, respectively, are coplanar, the elongate line can extend along first and second width directions. It should be appreciated, of course, that the first and second light beams 118 and 120 can be oriented such that the first and second width directions do not lie on the same plane. As will be described in more detail below, the combined energy produced by the first and second light beams 118 and 120 at the location of beam intersection 122 in the resin 101 causes the resin 101 to crosslink. The location of beam intersection 122 can be positioned so as to cause the rein 101 to bond to the electrical contacts 104.

During operation, referring now to FIGS. 3B-3D, the location of beam intersection 122 can be translated or otherwise moved with respect to the resin along a path of beam intersection travel so as to crosslink the resin 101 along the beam intersection path of travel. Thus, a method of cross-linking the resin so as to fabricate the housing 102 can include the step of sweeping the first and second light beams 118 and 120 so as to move the location of intersection 122 in the resin. For instance, the first and second light sources 114 and 116 can be pivoted so as to correspondingly change the trajectory of the first and second light beams 118 and 120 with respect to the resin 101, thereby correspondingly translating the location of beam intersection 122. Alternatively or additionally, the first and second light sources 114 and 116 can be translatable with respect to the resin 101 so as to correspondingly translate the location of beam intersection 122.

The sweeping step can include the step of sweeping the first and second light beams 118 and 120 along respective first and second sweeping directions in first and second sweeping planes that intersect the location of intersection. In one example, the first and second light sources 114 and 116 can be translatable and/or pivotable as described above. In another example, each of the first and second light sources 114 and 116 can be stationary but can have at least one mirror as described below that can angulate so as to cause the respective first and second light beams 118 and 120 to translate and/or pivot. Whether the light beams 118 and 120 translate or angulate, the light beams 118 and 120 can be swept along respective sweeping planes that intersect the location of beam intersection 122. In other examples, it is envisioned that the tank 124 can be movable with respect to the light sources 114 and 116 so as to move the location of beam intersection 122 with respect to the resin 101.

Thus, during use, the light beams 118 and 120 can be directed into the resin 101, such that the light beams 118 and 120 intersect each other at the location of beam intersection 122. In one example, the light beams 118 and 120 are directed into the resin, the beams 118 and 120 are then positioned to intersect in the resin 101. In other examples, the first and second beams 118 and 120 intersect, and the location of intersection is moved into the resin 101.

The location of beam intersection 122 can be elongate along a first direction D1, and the location of beam intersection 122 can be movable along the resin 101 along a second direction D2 that is angularly offset, such as perpendicular, to the first direction D1. The first and second directions D1 and D2 can define a first crosslink plane. In one example, the first direction D1 can be defined by one of the lateral direction A, the transverse direction T, and the longitudinal direction T as described above with respect to FIGS. 1A-1E. The second direction D2 can be defined by a different one of the lateral direction A, the transverse direction T, and the longitudinal direction L. During operation, the location of beam intersection 122 can be swept along the second direction D2 until the resin 101 has been crosslinked along a desired dimension of the housing 102 in the second direction D1. If the length of the location of beam intersection 122 is less than the desired dimension of the housing 102 along the first direction D1, the method of fabrication can include the steps of performing as many successive steps of moving the location of beam intersection 122 along the first direction D1 and sweeping the location of beam intersection 122 along the second direction D2 as many times as desired until the dimension of the housing 102 along the second direction has been achieved. Thus, the resin can be crosslinked in the first crosslink plane so as to define a desired footprint of the housing 102. The location of beam intersection can then be moved along a third direction D3 that is perpendicular to each of the first and second directions D1 and D2 so as to define a second crosslink plane, and the location of beam intersection 122 can be swept along the second crosslink plane so as to crosslink the resin 101 in the second crosslink plane. The method can include performing the initial step of sweeping the location of bream intersection 122 in a crosslink plane so as to crosslink the resin 101 in the crosslink plane, and moving the location of beam intersection 122 to a successive crosslink plane. The method can next include the successive steps of sweeping the location of bream intersection 122 in the crosslink plane so as to crosslink the resin 101 in the crosslink plane, and moving the location of beam intersection 122 in the third direction D3 to a further successive crosslink plane. Sweeping the location of beam intersection in successive crosslink planes can build the housing 102 to a desired height along the third direction D3.

Referring now to FIG. 3E, each light source 113 can include a light housing 223 and a light engine 224 is supported by the housing 223. The light engine 224 can include at least one light emitting diode (LED) 226 such as a plurality of LEDs 226a-c. Each LED 226 can emit a corresponding at least one light beam such as a plurality of light beams 228a-c, respectively. Thus, the light source 113 can be configured to emit at least one light beam 228 such as a plurality of light beams 228a-c. The at least one light beam 228 can have any suitable wavelength as desired. In one example, the wavelength can be in a range from approximately 250 nm to approximately 500 nm, such as from approximately 300 nm to approximately 400 nm, for instance from approximately 350 nm to approximately 400 nm. While three such light beams 228a-c are shown, the light source 113 can emit any suitable number of light beams 228 as desired, including four as described below with reference to FIG. 3G.

The at least one light beam 228 is reflected by or passes through a respective one or more dichroic mirrors 230, and passes through a respective at least one filter 232 that is configured to modify the spectra of each primary light source. All primaries of a projector were filtered by the same filter; however, different filters were used for each projector. In some examples, the at least one filter 232 can include a low pass filter and a high pass filter such that the wavelength of the exiting UV light is within a predetermined range. The range can be from approximately 300 nm to approximately 500 nm in some examples. In more specific examples, the wavelength of the light can be any one of approximately 365 nm, approximately 385 nm, approximately 405 nm, and approximately 460 nm. In should be appreciated that these wavelengths are presented by way of examples and not limitation, and it is envisioned that other wavelengths can be used. For instance, visible or infrared light ranges can be used. The wavelength of each of the light beams can be the same, and selected based on the resin to be cured. In other examples, the light beams can have different wavelengths as desired. The light beams 228 travel from the at least one filter 232 to a mircolens array 234, which homogenizes the light and thus neutralizes stray light that may be caused by the at least one filter 232. The light beams 228 traveling along parallel paths can then reflect off of a mirror 236, and subsequently passes a total internal reflection (TIR) prism 238. The light beams 228 can then be reflected by a digital micromirror device (DMD) 240, which forms the image that is defined by the light beams 228. The light beams 228 are reflected from pixels of the DMD 240 that are in the “ON” state to an inner reflective surface of the TIR prism 238, from where the light beams 228 are emitted from the light engine 224 through a projection lens 242. The light beams 228 do not reflect from pixels of the DMD 240 that are in the “OFF” state. Thus, controlling the ON/OFF state of the pixels the DMD 240 can control the final shape of the light beams 228 output from the light engine 224. It should be appreciated that the light beams 118 and 120 can be configured as described above with respect to the at least one light beam 228.

As described above with respect to FIG. 3E, and referring also to FIG. 3F, the light source 113 can be configured to shape the output light beams 228 as desired. For instance, some of the pixels of the DMD 240 can be on the ON state to allow the light beams 228 to reflect from those pixels and project from the light source 113. Other pixels of the DMD can be in the OFF state which prevents the light beams 228 from reflecting from those pixels. As a result, the corresponding output light beams 228 be patterned as desired. In particular, the output light beams 228 can define regions of light 126 and regions of light absence 128. Thus, the light beams 228 can be referred to as segmented as desired. As described above, the first and second light beams 118 and 120 produce sufficient energy to cross-link the resin 101 at regions where the light beams 118 and 120 intersect. The first and second light beams therefore can define segmented locations of intersection 122 where at least one of the first and second light beams defines a light absence 128. Therefore, at least one or neither of the first and second light beams 118 and 120 applies energy at the segmented locations of intersection 122, and insufficient energy therefore exists at the segmented locations of intersection 122 to cause the resin 101 to cross-link. At locations of intersection where both light beams 118 and 120 define respective regions of light 126 and 136, the light beams 118 and 120 combine to produce energy levels sufficient to cross-link the resin 101. In this regard, each fabrication station 105 (see FIG. 2A) can control regions where the resin 101 crosslinks by modulating the corresponding light sources to define desired regions of light and desired regions of light absence.

As illustrated in FIG. 3F therefore, the location of beam intersection 122 can be segmented. Accordingly, in one example the location of beam intersection 122 can define a plurality segmented elongate lines of light 130. The segmented elongate lines can be collinear with each other. For instance, the first light beam 118 can be segmented so as to define a first segmented light beam 132 that is defined by a corresponding plurality of first light regions 126 that are aligned with each other along the first width, and first regions of light absence 128 disposed between the first light regions 126 along the first width direction. For instance, the first light regions 126 and first regions of light absence 128 can be alternatingly arranged along the first width direction. Similarly, the second light beam 120 can be segmented so as to define a second segmented light beam 134 is defined by a corresponding plurality of second light regions 136 that are aligned with each other along the second width, and second regions of light absence 138 disposed between the second light regions 136 along the second width direction. For instance, the second light regions 136 and second regions of light absence 138 can be alternatingly arranged along the second width direction. The first and second segmented light beams 132 and 134 can therefore intersect respective different ones of the second beam segments such that the location of intersection 122 defines a plurality of line segments spaced from each other along either or both of the first and second width directions.

The location of beam intersection 122 can include the elongated segmented lines of light 130 at locations whereby the first and second light regions 126 and 136 intersect, and intersected regions of light absence 139 at locations along the location of beam intersection 122 between the segmented lines of light 130 where at least one or both of the first and second regions of light absence 128 and 138 occur.

It should be appreciated that neither the first light regions 126 nor the second light regions 136 has an individually sufficient level of energy to cause the resin 101 to crosslink. However, the first and second light regions 126 and 136 have a combined level of energy that is sufficient to cause the resin 101 to crosslink. Therefore, when the first and second segmented light beams 132 and 134 are segmented and directed into the resin 101 (see FIG. 2A), the resin will be crosslinked only at locations where the first and second segmented light regions 126 and 136 intersect at the segmented elongate lines 130. In this manner, the resin 101 can be crosslinked at desired locations without being cross-linked at other locations where first and second segmented light regions do not intersect (i.e., at the intersected regions of light absence 139). The other locations can therefore define one or more voids or openings in the resulting housing 102 during successive sweeps of the location of beam intersection 122.

Referring to FIG. 3G, and as described above with respect to FIG. 3E, each of the first and second light sources 114 and 116 can produce a respective single light beam or a plurality of light beams as desired. For instance, the first light source 114 can emit and direct a plurality of first light beams 118a-118d to the resin 101, and the second light source 116 can emit and direct a plurality of second light beams 120a-120d to the resin 101. Thus, the at least one first light beam 118 can be configured as a plurality of first light beams 118a-118d, and the at least one second light beam 120 can be configured as a plurality of second light beams 120a-120d. While four such light beams are illustrated, it should be appreciated that any number of light beams can be used as desired, including two, three, five, six, seven, eight, nine, ten, or more. The first light beams 118a-118d can be spaced from each other along a direction that is substantially perpendicular to the first common light beam plane of each of the beams 118a-118d. The first light beam planes, and thus the first beams 118a-118d, can extend along respective first planes that are defined by the respective first length and width directions and can be parallel to each other. Alternatively, the first light beam planes, and thus the first light beams 118a-118d, can diverge from each other or converge toward each other in a direction travel toward the resin 101. Similarly, the second light beams 120a-120d can extend along respective second light beam planes that are defined by the respective second length and width directions and can be parallel to each other. The second light beams 120a and 120d can be spaced from each other along a direction that is substantially perpendicular to the second light beam plane of each of the beams 120a-120d. The second light beam planes, and thus the second light beams 120a-120d, can extend parallel to each other. Alternatively, the second light beam planes, and thus the second light beams 120a-120d, can diverge from each other or converge toward each other in a direction travel toward the resin 101.

Each of the light beams 118a-118d of the first light source 114 can intersect respective at least ones of the light beams 120a-120d of the second light source 116 in the resin 101 so as to define a corresponding plurality of locations of intersection 122. Some of the light beams 118a-118d can also intersect a plurality of the light beams 120a-120d at various locations outside the resin 101, but those intersections do not contribute to cross-linking of the resin 101 and therefore do not constitute locations of beam intersection of the type described above. For instance, one of the first light beams 118a-118d can intersect each of the second light beams 120a-120d. Similarly, one of the second light beams 120a-120d can intersect each of the first light beams 118a-118d. Further, one of the first light beams 118a-118d intersects only one of the second light beams 120a-120d. Similarly, one of the second light beams 120a-120d intersects only one of the first light beams 118a-118d. It is appreciated that adjacent ones of the locations of beam intersection 122 are spaced from each other by a distance along the second direction. Further, the locations of beam intersection 122 can be coplanar with each other in the respective crosslink plane. Thus, in one example, the light beams 118a-118d and the light beams 120a-120d can be swept a distance that is equal to the distance between adjacent ones of the locations of beam intersection 122, such that the swept locations of beam intersection 122 in the crosslink plane combine to define the desired footprint of the housing 102 along the crosslink plane that includes the first and second directions D1 and D2. It should be appreciated that any one or more up to all of the first and second light beams 118 and 120 can be segmented along their respective widths or continuous along respective entireties of their respective widths as desired.

The additive fabrication system 100 will now be described in greater detail with reference to FIGS. 2A-2B and 4A-6. Referring initially to FIGS. 2A-2B, each fabrication station 105 can include first and second light sources 114 and 116 that are configured to deliver energy to the resin 101 that causes the resin 101 to crosslink in the manner described above, thereby fabricating the solid polymer housing 102 of the type described herein. The additive fabrication system 100 can include a first drive system 142a that is configured to direct the electrical contacts 104 into each tank 124 that contains a viscous resin 101 that is to be applied to the electrical contacts 104. The first drive system 142a can include a plurality of drive members 144, such as rollers or the like, that are configured to drive the electrical contacts 104 to travel along a direction of travel and a desired path that subjects the electrical contacts 104 to the resin 101 and processing steps as desired. The electrical contacts 104 can be provided in strips 103 having lengths sufficient to fabricate multiple housings 102 having separate electrical contacts 104. In particular, multiple housings 102 can be formed along the strips 103, and the strips can be severed so as to produce singulated wafers 110 each having a housing 102 defined by the crosslinked resin 101, and a respective number of the electrical contacts 104 supported by the housing 102. In other examples, the strips 103 can be oriented in a direction perpendicular to the direction of travel and the desired path, and can be supported by a carrier strip. For instance, sacrificial metal can join the electrical contacts 104 to a polymeric carrier strip. The sacrificial metal can be ablated in subsequent steps.

The electrical contacts 104 can be created by stamping a metal sheet. While the strips 103 can be shown as a solid sheet in the drawings, it is appreciated that the strips 103 can be separated into a plurality of electrical contacts 104 as shown at FIG. 2A. Subsequently, the electrical contacts 104 can be formed as desired at the mating ends and mounting ends. In one example, the housing 102 can be fabricated in the manner described herein, and the electrical contacts 104 supported by the housing 102 can subsequently be formed during one or more processing steps. The electrical contacts 104 can define a first surface 107a that faces a first region 147 of the resin 101, and a second surface 107b that faces a second region 149 of the resin 101. The first and second surfaces 107a and 107b can be opposite each other along the column direction. The first and second surfaces 107a and 107b can be defined by broadsides of the electrical contacts 104. The electrical contacts further define edges that extend between the first and second surfaces 107a and 107b. The broadsides are longer than the edges in a plane that intersects the electrical contacts and is perpendicular to the electrical contacts. Thus, the edges can face each other along the rows. The electrical contacts can therefore be said to be edge coupled, whereby the edges of electrical contacts 104 that define a differential pair face each other along the row direction. Alternatively, the electrical contacts 104 can be broadside coupled, whereby the broadsides of electrical contacts 104 that define a differential pair face each other along the row direction.

Prior to introducing the electrical contacts 104 into the resin 101, a release layer can be applied to the electrical contacts 104. The release layer 109 prevents the resin 101 from bounding to the electrical contacts 104. Thus, the release layer 109 can be applied to at least one portion of at least one of the surfaces 107a and 107b of the electrical contacts 104 that prevents the resin 101 from bonding to the at least one portion when it is crosslinked against the electrical contact. Thus, the resin 101 can be selectively bonded to different locations along the respective lengths of the electrical contacts 104. In some examples, the release layer 109 can be aligned with voids or openings in the housing 102, which may be desirable to control the dielectric between adjacent linear arrays 47, which can affect impedance.

The release layer 109 can also be applied to the strips 103 of electrical contacts 104 that prevents the resin 101 from being bonded to the strips 103 at locations between the respective housings 102 with respect to the longitudinal direction L. Thus, the fabrication stations 105 can continuously apply the light beams 118 and 120 to the resin 101 as the strips 103 travel through the resin 101, which will cause the resin 101 to bond to only those locations of the strips 103 of electrical contacts that are not coated with the release layer. Thus, a plurality of housings 102 can be fabricated onto the strips 103 of electrical contacts 104, whereby the housings 102 are spaced from each other along the lengths of the strips 103.

The release layer 109 can further be applied to the strips 103 of electrical contacts 104 that prevents the resin 101 from being bonded to the strips 103 at locations between the respective housings 102 with respect to the transverse direction T. Thus, the fabrication stations 105 can continuously apply the light beams 118 and 120 to the resin 101 as the strips 103 travel through the resin 101, which will cause the resin 101 to bond to only those locations of the strips 103 of electrical contacts that are not coated with the release layer. Thus, a plurality of housings 102 can be fabricated onto the strips 103 of electrical contacts 104, whereby the housings 102 are spaced from each other along the widths of the strips 103. Thus, some of the strips 103 can be supported by first columns of housings 102, and others of the strips 103 can be supported by second columns of housings 102 that are spaced from the first columns of housings 102 along the transverse direction T.

Each fabrication station 105 can further include a camera 146 that is positioned such that at least the region of intersection 122 of the fabrication station 105 is in the field of view of the camera 146. In one example, an entirety of the housing 102 being fabricated at the respective fabrication station 105 can be in the field of view of the camera. In one example, quality control can be made based at least in part on images from the camera 146. The camera 146 can be positioned between the first and second light sources 114 and 116 in one example.

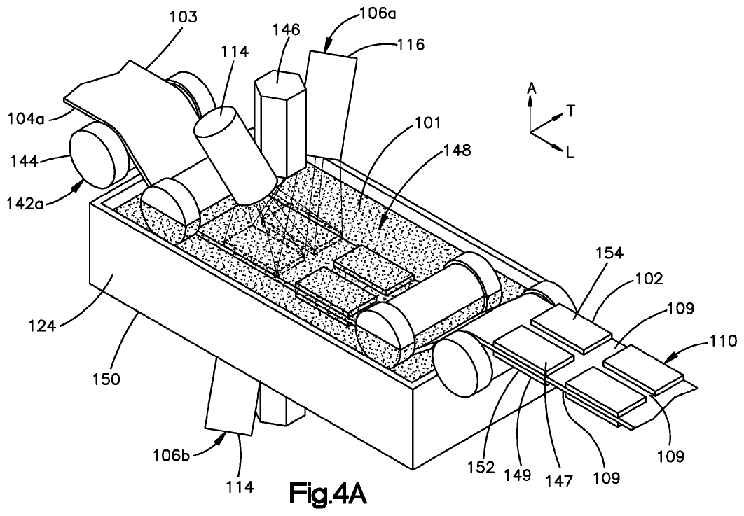

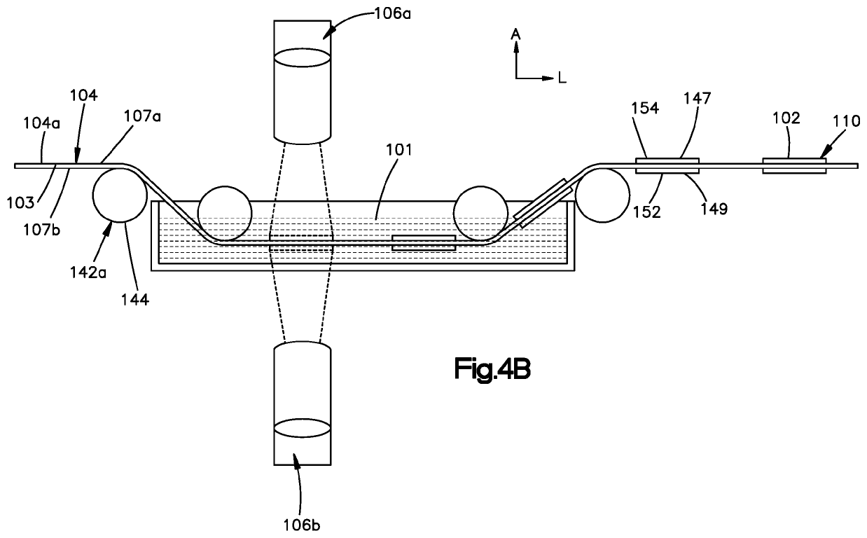

Referring again to FIGS. 2A-2B and also to FIGS. 4A-4B, the initial fabrication station 106 can include a first initial fabrication station 106a and a second initial fabrication station 106b that are configured to additively fabricate crosslinked resin on opposed sides of the first electrical contacts 104a. For instance, the first initial fabrication station 106a is configured to build a first region 147 of crosslinked resin 101 onto the first surface 107a of the first plurality of electrical contacts 104a. In particular, the first and second light beams 118 and 120 of the first initial fabrication station 106a can be directed into the resin 101 so as to define their respective at least one first location of beam intersection 122 (see FIGS. 3B and 3F) in a first region 147 of resin 101 so as to crosslink the resin 101 at the first region. The at least one first location of beam intersection 122 can be swept in the manner described above to build the first region 147 of crosslinked resin. The first surfaces 107a of the first plurality of electrical contacts 104a can face the first region 147 of crosslinked resin 101, such that the first region 147 of crosslinked resin 101 bonds to the first surfaces 107a.

Similarly, the second initial fabrication station 106b is configured to build a second region 149 of crosslinked resin 101 onto the second surface 107a of the first plurality of electrical contacts 104a. In particular, the first and second light beams 118 and 120 of the second initial fabrication station 106b can be directed into the resin 101 so as to define their respective at least one second location of beam intersection 122 (see FIGS. 3B and 3F) in a second region 149 of resin 101 so as to crosslink the resin 101 at the second region 149. The at least one second location of beam intersection 122 can be swept in the manner described above to build the second region 149 of crosslinked resin 101. The second surface 107b of the first plurality of electrical contacts 104a can face the second region 149 of crosslinked resin 101, such that the second region 149 of crosslinked resin 101 bonds to the second surfaces 107b.

The second region 149 of crosslinked resin 101 can define an external surface 152 of the housing 102. The first region 147 of crosslinked resin can define an opposed surface 154 that can bond to the resin 101 of a subsequent fabrication station 108 or define an external surface of the housing 102 as desired. The resin 101 of the subsequent fabrication station 108 can bond to the opposed surface 154 defined by the preceding fabrication station so as to define a subsequent opposed surface 154. The opposed surface 154 produced by the final subsequent fabrication station 108 can define an external surface of the housing 102.

The first and second locations of beam intersection 122 can build crosslinked resin 101 in the respective first and second regions 147 and 149 of resin so as to define the housing 102 that supports and surrounds at least a portion of the first electrical contacts 104a. The first and second regions 147 and 149 of crosslinked resin 101 can abut each other and bond to each other such that the electrical contacts 104a are fully surrounded by crosslinked resin 101 in a plane that is oriented perpendicular to the longitudinal direction L of the electrical contacts 104a. The crosslinked resin 101 can bond to either or both of the broadsides and the edges of the electrical contacts 104.

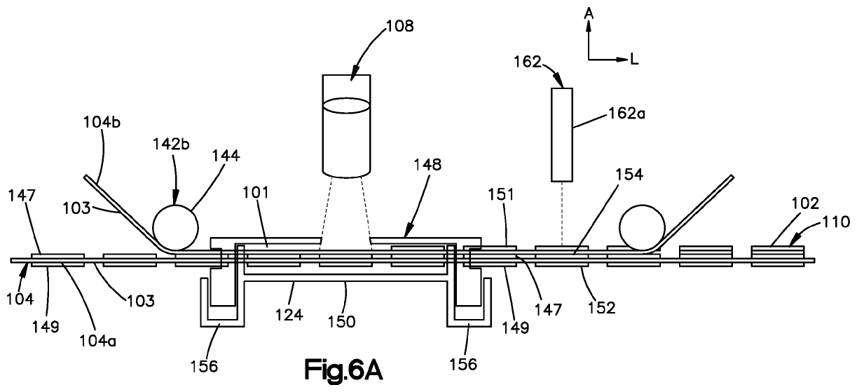

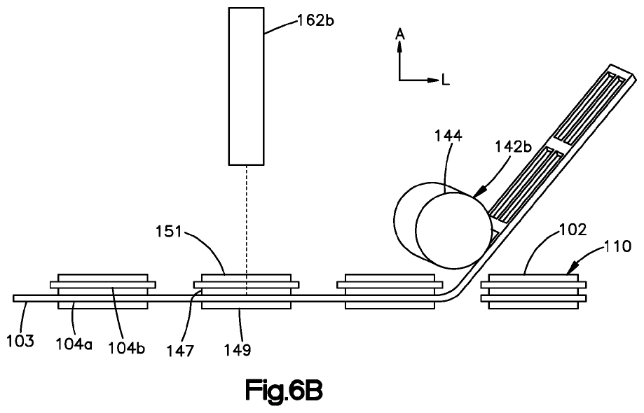

As shown in FIGS. 2A-2B and 4A-4B, each fabrication station 105 can include a respective tank 124 that contains the resin 101. In some examples resin 101 can flow from a resin source into the tank 124 to replace the resin 101 that is crosslinked to define the housing 102. The initial fabrication station 106 can further include an overflow reservoir 156 (see FIG. 6A) that receives excess resin 101 that has been delivered to the tank 124. The resin 101 in the overflow reservoir 156 can be recirculated and delivered to the tank 124 as desired. The tank 124 can have an open end 148 that is open to the first and second light beams 118 and 120 of the first initial fabrication station 106a. The tank 124 can have a closed end 150 that faces the first and second light beams 118 and 120 of the second initial fabrication station 106b. The closed end 150 can be optically transparent so as to allow the beams 118 and 120 to enter the resin 101 and define the locations of beam intersection 122 in the resin 101 in the manner described above.

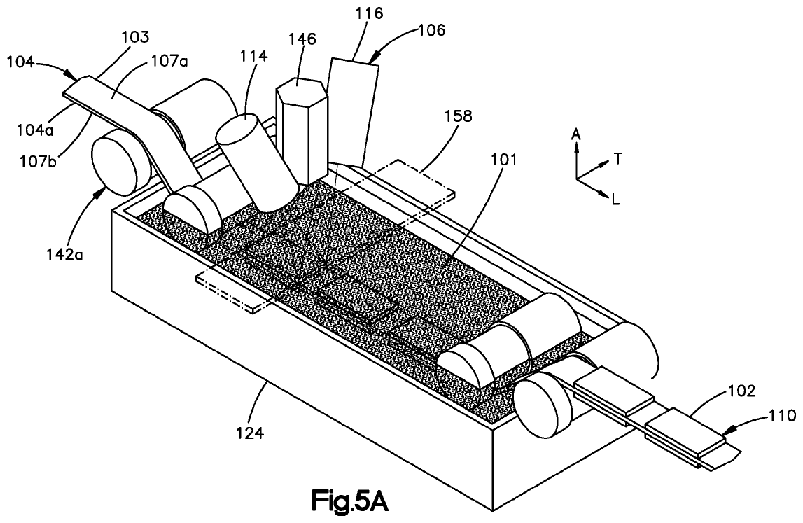

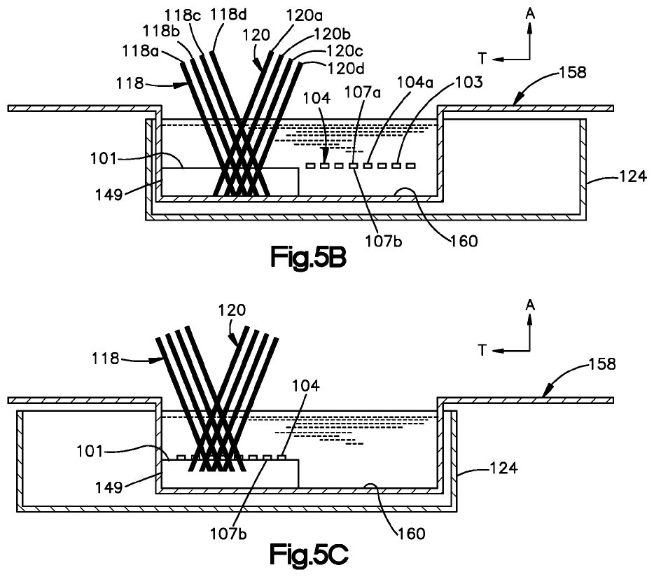

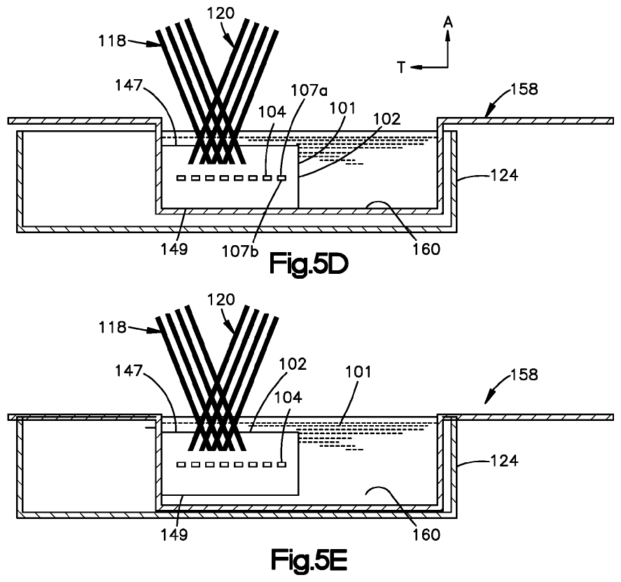

Referring now to FIGS. 5A-5E, in another example the initial fabrication station 106 can be configured as a single fabrication station that is configured to produce the first and second regions 147 and 149. The initial fabrication system 106 can include a shuttle 158 having a fabrication platform 160 and an initial position whereby the fabrication platform is offset with respect to the strip 103 of electrical contacts 104. For instance, as illustrated at FIG. 5B, the fabrication platform 160 can disposed in the resin 101 at a location that is initially offset from the strip 103 of electrical contacts 104 along the transverse direction T. The first and second light sources 118 and 120 can be directed to the second region of resin 101 that is disposed on the fabrication platform 160 so as to fabricate the second region 149 of crosslinked resin 101 on the fabrication platform 160.

As illustrated at FIG. 5C, once the second region 149 has been fabricated on the fabrication platform 160, the shuttle 158 can be moved along the transverse direction T to an aligned position whereby at least a portion of the fabrication platform 160 and thus the second region 149 of crosslinked resin 101 are aligned with the strip 103 of electrical contacts 104 along the lateral direction A. In this regard, it should be appreciated that the fabrication platform 160 can be movable along a direction that is parallel to the crosslink plane. Thus, the second region 149 of crosslinked resin 101 can face the second surfaces 107b of the strip 103 of electrical contacts 104. In some examples, the second region 149 of crosslinked resin 101 can abut the second surfaces 107b, for instance, by moving the second region 149 of crosslinked resin 101 toward the electrical contacts 104 along the lateral direction A.

As illustrated at FIG. 5D, the first region 147 of crosslinked resin 101 can be fabricated by crosslinking the resin 101 of the first region 147 so as to bond the first region 147 to the second region 149 and to the strips 103 of electrical contacts 104, thereby creating the housing 102. Finally, as illustrated at FIG. 5E, the shuttle can be moved along the lateral direction A away from the second surfaces 107b of the strips 103 of electrical contacts, which causes the second region 149 of crosslinked resin to delaminate from the fabrication platform 160. The steps can be repeated to build crosslinked resin 101 onto the different locations of the electrical contacts 104 once the drive system 142a has caused the strips 103 of electrical contacts 104 to advance along the longitudinal direction L.

Referring now to FIG. 6A, the subsequent fabrication station 108 is configured to add to the wafer 110 1) a subsequent row of electrical contacts 104 defined by a subsequent plurality of electrical contacts 104b, and 2) a subsequent region 151 of resin 101 to the first region 147. When the preceding fabrication station is defined by the initial fabrication station 106, the subsequent plurality of electrical contacts 104b can be referred to as a second plurality of electrical contacts 104b arranged along a second row. The first drive system 142a can deliver the wafers 110 produced by the preceding fabrication station 106 to the viscous resin 101 that is disposed in the tank 124 of the subsequent fabrication system 108. The subsequent fabrication station 108 can include a subsequent drive system 142b that delivers a subsequent strip 103b of the subsequent plurality of electrical contacts 104b to the bath of resin 101 that is disposed in the tank 124 of the subsequent fabrication station 108. When the preceding fabrication station is defined by the initial fabrication station 106, the subsequent drive system 142b can be referred to as a second drive system, and the subsequent strip 103b can be referred to as a second strip.

The wafer 110 produced at the preceding fabrication station 106 can be delivered to the viscous resin 101 of the subsequent fabrication station 108 such that the first surface 154 faces the first and second light sources of the subsequent fabrication station 108. The subsequent strip 103b of the electrical contacts 104b can be delivered by the subsequent drive system 142b into the resin 101 such that the subsequent strip 103b is disposed on the first surface 154 in the resin 101. The subsequent fabrication stations 108 directs respective first and second light beams 108 and 110 into the viscous resin 101 to crosslink the resin 101 in the manner described above. In particular, the crosslinked resin 101 is bonded to both the first surface 154 and the subsequent strip 103b of electrical contacts 104b, thereby adding the subsequent row of electrical contacts 104b to the wafer 110. The first and second light beams 108 and 110 are swept in the manner described above until the desired footprint of the housing 102 is crosslinked at the desired height. The first surface 154 of the wafer is thus defined by the crosslinked resin added at the subsequent fabrication station 106. The additive fabrication system 100 can include any number of subsequent fabrication stations 108 to correspondingly add any number of subsequent rows of electrical contacts 104 to the wafer 110 as desired.

As described above, a plurality of housings 102 can be fabricated onto the strips 103 of electrical contacts 104 wafers 110 at locations spaced from each other along the longitudinal direction L. The additive fabrication system 100 can further include one or more ablation stations 162 that are configured remove material from the strips 103 of electrical contacts. In particular, as shown at FIG. 6A, a first ablation station 162a can be configured to cut and remove the sacrificial metal from the electrical contacts 104 of the strips 103, thereby also removing the carrier strip which can be polymeric or metal as desired. Further, the ablation station 162a can cut and remove any excess resin that extends beyond the housing 102 as desired. The removed excess material can be directed to a take-up reel and discarded as desired. The first ablation station 162a can further be configured to sever the respective one of the strips 103 at locations between adjacent ones of the housings 102 both along the longitudinal direction L and along the transverse direction T, thereby singulating the wafers 110 if no other strips 103 remain unsevered. The first ablation station 162a can remove the excess material and sever respective one of the strips after the subsequent fabrication station 108 has produced the subsequent row of electrical contacts 104, such that the remaining strips 103 can create a carrier that allows the first drive system 142a to transport the resulting wafer 110.

Referring to FIG. 6B, once a final subsequent fabrication station 108 has completed adding a final row of electrical contacts 104 to the wafer 110, one or more subsequent ablation stations 162b can remove the electrical contacts 104 from the carrier strips, or excess cured resin, as described above. Thus, the wafers 110 can be singulated. It should be appreciated that the excess material can be removed and discarded. While the additive fabrication system can include a plurality of ablation stations 162 in the manner described above, in other examples a single ablation station 162 can remove all excess materials from all of the strips, and sever all of the strips between the wafers 110. In some examples, a portion of the sacrificial metal can remain if desired to be used as a weld tab to provide additional rigidity, for example in instances whereby the connector is mounted to an underlying substrate such as a printed circuit board.

In still other examples, a first ablation station 162 can remove all of the strips 103 except for at least one remaining strip, and the at least one remaining strip can carry the wafers 110 for transportation by the first drive system 142a to one or more processing stations. Alternatively, the wafers 110 can be singulated and individually transported to the processing stations. At one processing station, the mating ends and mounting ends can be formed and shaped as desired. At another processing station, one or more ground plates can be attached to the housing 102 in the manner described above, which can be desirable if the electrical contacts 104 comprise only signal contacts. At another processing station, the wafers 110 can be placed in an ultrasonic bath configured to remove viscous resin 101 that has not cross-linked from the electrically insulative housing 102.

1. A method for additively fabricating an electrical component, the method comprising the steps of:
directing first and second light beams from first and second light sources, respectively, toward a resin, wherein the first and second light directed beams have respective energy levels that are insufficient to crosslink the resin;
intersecting the first and second light beams in the resin so as to define a location of beam intersection along the first and second widths, wherein the location of beam intersection defines an elongate line and has an energy level sufficient to crosslink the resin, such that the intersecting step crosslinks the resin and bonds the resin to a plurality of electrical contacts when the location of beam intersection is in the resin.

2. (canceled)

3. (canceled)

4. The method of claim 1, further comprising the step of maintaining a Moiré' interference out of the resin during the intersecting step.

5. The method of claim 1, further comprising the step of sweeping the first and second light beams so as to move the location of intersection in the resin.

6. The method of claim 5, wherein the sweeping step comprises sweeping the first and second light beams along respective first and second sweeping directions in first and second sweeping planes that intersect the location of beam intersection.

7. (canceled)

8. The method of claim 1, wherein the first light beam extends along a first length to the resin, the first light beam defining a first width perpendicular to the first length, wherein the first length and the first width are oriented along a common first plane.

9. The method of claim 8, wherein the second light beam extends along a second length to the resin, the second light beam defining a second width perpendicular to the second length, wherein the second length and the second width are oriented along a common second plane that intersects the common first plane to define the location of beam intersection.

10. The method of claim 9, wherein the location of beam intersection is continuous along an entirety of at least one of the first and second widths.

11. The method of claim 10, wherein the location of beam intersection is continuous along an entirety of each of the first and second widths so as to define a straight line.

12. The method of claim 9, wherein the location of beam intersection defines a plurality segmented elongate lines.

13. The method of claim 12, wherein the segmented elongate lines are collinear.

14. The method of claim 12, wherein the first beam comprises a first segmented light beam having first regions of light that are aligned with each other along the first width.

15. The method of claim 14, wherein the second beam comprises a second segmented light beam having second regions of light that are aligned with each other along the second width.

16. The method of claim 15, wherein each of the first regions of light intersects a respective different one of the second regions of light such that the location of beam intersection comprises a plurality of line segments.

17. The method of claim 1, wherein the first and second beams have respective wavelengths in a range from approximately 350 nm to approximately 400 nm.

18. The method of claim 1, wherein the first light beam comprises a plurality of first light beams, and the second light beam intersects at least one of the plurality of first light beams in the resin.

19. The method of claim 18, wherein the plurality of first light beams extends along respective first planes to the resin, wherein the first planes are spaced from each other, and the second light beam intersects at least one of the first light beams.

20. The method of claim 1, wherein the second light beam comprises a plurality of second light beams, and each first light beam intersects at least one of the second light beams in the resin.

21. The method of claim 20, wherein each of the second light beams extend to the resin along respective second planes that are spaced from each other.

22. The method of claim 1, further comprising the step of stamping and forming a metal sheet so as to define the plurality of electrical contacts, and bringing the plurality of electrical contacts into the resin prior to the step of intersecting.

23. The method of claim 22, further comprising the step of applying a release layer onto at least one portion of a surface of the electrical contacts to prevent bonding of the resin to the at least one portion.

24. The method of claim 1, further comprising the steps of bonding the resin to different locations along respective lengths of the electrical contacts, and severing the electrical contacts between the locations so as to produce singulated wafers each having a wafer housing defined by the crosslinked resin, and a respective number of electrical contacts supported by the wafer housing.

25. The method of claim 1, further comprising:
directing the location of beam intersection toward a platform of a shuttle so as to cause the resin to crosslink on the platform while the platform is spaced from the electrical contacts;
after the step of directing the location of beam intersection toward the platform, moving the shuttle such that the crosslinked resin on the platform is aligned with the electrical contacts;
after the moving step, directing the location of beam intersection toward the resin to crosslink the resin onto each of 1) the crosslinked resin on the platform, and 2) the electrical contacts.

26. The method of claim 25, further comprising the step of removing the platform from the crosslinked resin.

27. The method of claim 25, wherein the step of moving the shuttle causes such that the crosslinked resin on the platform to abut the electrical contacts.

28. The method of claim 1, wherein the first and second light beams are of a first fabrication station, and the location of intersection causes the resin to bond to a first surface of the electrical contacts, the method further comprising the steps of:
directing first and second light beams from first and second light sources of a second fabrication station so as to define a second location of beam intersection of the second fabrication station in the resin so as to crosslink the resin and bond the resin to a second surface of the plurality of electrical contacts opposite the first surface.

29-55. (canceled)
